(19) United States
(12) Patent Application Publication
(10) Pub. No.: US 2018/0156164 A1
(43) Pub. Date: Jun. 7, 2018

(54) TURBINE HOUSINGS AND TURBINE HOUSING MANIFOLDS HAVING INTEGRATED BYPASS VALVES FOR DEDICATED EXHAUST GAS RECIRCULATION ENGINES

(71) Applicant: GM GLOBAL TECHNOLOGY OPERATIONS LLC, Detroit, MI (US)

(72) Inventors: Edward J. Keating, Ortonville, MI (US); Prabjot Nanua, Ann Arbor, MI (US)

(21) Appl. No.: 15/367,848

(22) Filed: Dec. 2, 2016

(51) Int. Cl. F02M 26/04; F02B 37/18; F02M 26/09; F02M 26/34; F02M 26/71

(52) U.S. Cl. CPC F02M 26/04; F02B 37/18; F02M 26/71; F02M 26/34; F02M 26/09

(57) ABSTRACT

Provided herein are turbocharger manifolds, and turbocharger and exhaust gas recirculation (EGR) systems incorporating the same. The manifold comprises a body, at least one non-dedicated EGR vein, a dedicated EGR vein, and an EGR bypass valve in fluid communication with the dedicated EGR vein, wherein the dedicated EGR vein converges with the at least one non-dedicated EGR veins downstream from the EGR bypass valve. The dedicated EGR vein is in fluid communication with an EGR conduit. The EGR bypass valve can selectively allow or prevent fluid communication between the dedicated EGR vein and the EGR conduit. The EGR bypass valve can comprise a two-way valve having a gate movable from a first position to a second position. The manifold can comprise a one-piece construction with a turbocharger turbine housing.

### BACKGROUND

During a combustion cycle of an internal combustion engine (ICE), air/fuel mixtures are provided to cylinders of the ICE. The air/fuel mixtures are compressed and/or ignited and combusted to provide output torque. Many diesel and gasoline ICEs employ a supercharging device, such as an exhaust gas turbine driven turbocharger, to compress the airflow before it enters the intake manifold of the engine in order to increase power and efficiency. Specifically, a turbocharger uses a centrifugal gas compressor that forces more air (i.e., oxygen) into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

### SUMMARY

According to an aspect of an exemplary embodiment, a turbocharger turbine housing manifold is provided. The manifold can comprise a body, at least one non-dedicated exhaust gas recirculation (EGR) vein, a dedicated EGR vein, and an EGR bypass valve in fluid communication with the dedicated EGR vein. The dedicated EGR vein can converge with the at least one non-dedicated EGR veins downstream from the EGR bypass valve. The dedicated EGR vein can be in fluid communication with an EGR conduit. The EGR bypass valve can selectively allow or prevent fluid communication between the dedicated EGR vein and the EGR conduit. The EGR bypass valve can comprise a two-way valve having a gate movable from a first position to a second position, wherein when the gate is in the first position the dedicated EGR vein is in fluid communication with the at least one non-dedicated EGR veins, and when the gate is in the second position the dedicated EGR vein is in fluid communication with the EGR conduit. The manifold can further comprise a wastegate valve disposed downstream from the EGR bypass valve.

According to another aspect of an exemplary embodiment, a turbocharger can include a compressor disposed within a compressor housing, a turbine mechanically coupled to the compressor and disposed within a turbine housing. The turbine housing can include a manifold having a plurality of veins which converge therein and establish fluid communication with the turbine, and at least one of the veins can be a dedicated EGR vein having an EGR bypass valve. The at least one dedicated vein can converge with at least one of the remaining veins downstream from the EGR bypass valve. The manifold and turbine housing can be a one-piece construction. The EGR bypass valve can selectively allow or prevent fluid communication between the dedicated EGR vein and the turbine. The one or more of the at least one dedicated EGR veins can be in fluid communication with an EGR conduit. The EGR bypass valve can selectively allow or prevent fluid communication between the one or more dedicated EGR veins and the EGR conduit. The EGR bypass valve can comprise a two-way valve having a gate movable from a first position to a second position, wherein when the gate is in the first position the dedicated EGR vein is in fluid communication with the at least one non-dedicated EGR veins, and when the gate is in the second position the dedicated EGR vein is in fluid communication with the EGR conduit. The turbocharger can further comprise a wastegate valve disposed downstream from the EGR bypass valve.

According to an aspect of an exemplary embodiment, an EGR system can comprise an internal combustion engine having an air intake manifold configured for delivering air to a plurality of cylinders, wherein one of the plurality of cylinders is a dedicated EGR cylinder, an EGR conduit in fluid communication with the air intake manifold, and a turbocharger having a turbine disposed within a turbine housing and in fluid communication with the plurality of cylinders via a turbine manifold. The turbine manifold can include a body, at least one non-dedicated EGR vein disposed within the body, a dedicated EGR vein disposed within the body in fluid communication with the dedicated EGR cylinder and the EGR conduit, and an EGR bypass valve in fluid communication with the dedicated EGR vein. The dedicated EGR vein can converge with the at least one non-dedicated EGR veins downstream from the EGR bypass valve. The EGR bypass valve can selectively allow or prevent fluid communication between the dedicated EGR vein and the EGR conduit. The EGR bypass valve can comprise a two-way valve having a gate movable from a first position to a second position, wherein when the gate is in the first position the dedicated EGR vein is in fluid communication with the at least one non-dedicated EGR veins, and when the gate is in the second position the dedicated EGR vein is in fluid communication with the EGR conduit. The manifold and turbine housing can be a one-piece construction. The system can further include a conduit in fluid communication with at least one of the one or more non-dedicated EGR cylinders and at least one of the non-dedicated EGR veins. The system can further include a conduit in fluid communication with the dedicated EGR cylinder and the dedicated EGR vein.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 is a schematic diagram of an internal combustion engine assembly with a dedicated exhaust gas recirculation, according to one or more embodiments.

FIG. 2 is a perspective view of a turbocharger, according to one or more embodiments.

FIG. 3A is a perspective view of a turbocharger turbine housing manifold, according to one or more embodiments.

FIG. 3B is cutaway view of a turbocharger turbine housing manifold, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are turbocharger turbine housing manifolds, and turbochargers and exhaust gas recirculation (EGR) systems incorporating the same. The manifolds each comprise one or more EGR bypass valves which increase the efficiency of turbochargers by reducing pressure and thermal losses of exhaust gasses passing therethrough. Increases in efficiency are gained by virtue of the construction and position of the EGR bypass valves within a turbocharger manifold or turbine housing.

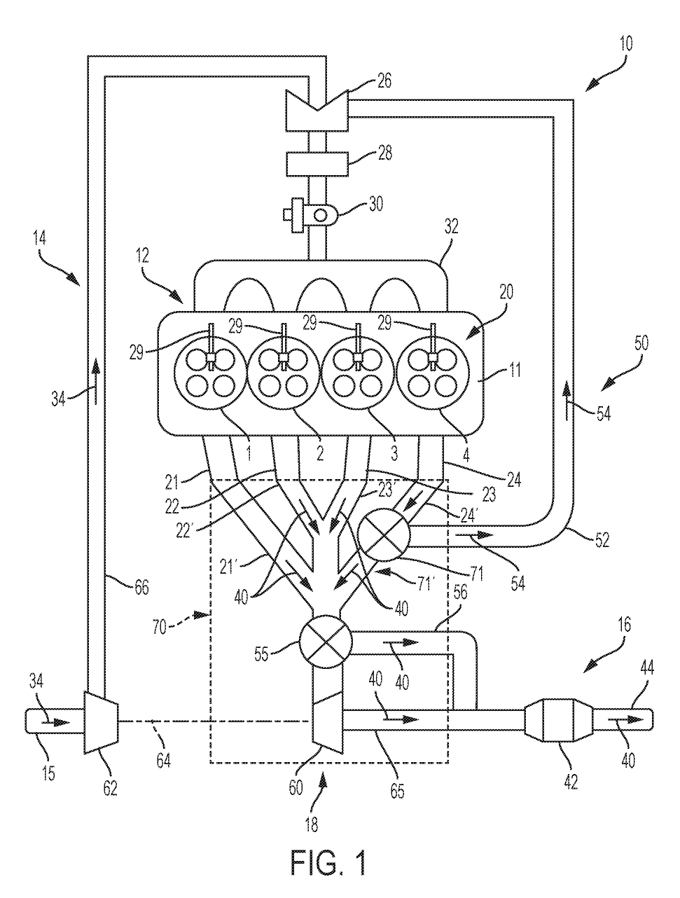

Referring to the drawings, wherein like reference numerals are used to identify like or identical components in the various views, FIG. 1 schematically illustrates an engine assembly 10 including an internal combustion engine 12, an air intake system 14, and an exhaust system 16. The air intake system 14 and the exhaust system 16 may each respectively be in fluid communication with the internal combustion engine (ICE) 12, and may be in mechanical communication with each other through a turbocharger 18.

ICE 12 includes a cylinder block 11 which defines a plurality of cylinders 20 (referenced as cylinders 1-4). ICE 12 can be of a spark ignition or a compression ignition design. ICE 12 is illustrated as an inline four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations. In some specific embodiments, ICE 12 can comprise an inline three or six cylinder engine. In other specific embodiments, ICE 12 can comprise V-6, V-8, V-10, and V-12 configuration engines, among others. Each of the cylinders 20 can include a piston (not shown) configured to reciprocate therein, wherein a cylinder 20 and its respective piston can define a combustion chamber. Each of the respective cylinders 20 may include one or more fuel injectors 29 that may selectively introduce liquid fuel (as an aerosol) into each cylinder for combustion. Each of the cylinders 20 may be in selective fluid communication with the air intake system 14 to receive fresh/oxygenated air, and the cylinders 20 can be in selective fluid communication with the exhaust system 16 to expel the byproducts of combustion. Each of cylinders 1, 2, 3, and 4 expel exhaust gas 40 away from ICE 12 via dedicated conduits 21, 22, 23, and 24, respectively. The exhaust gasses 40 can subsequently pass through one or more aftertreatment devices, such as device 42, to catalyze and/or remove certain byproducts prior to exiting the exhaust system 16 via a tailpipe 44.

The air intake system 14 may generally include a fresh-air inlet 15, an EGR mixer 26, a charge air cooler 28, a throttle 30, and an intake manifold 32. As may be appreciated during operation of ICE 12 fresh air 34 may be ingested by the air intake system 14 from the atmosphere or from an associated air-cleaner assembly via the fresh-air inlet 15. The throttle 30 may include a controllable baffle configured to selectively regulate the total flow of air through the intake system 14, and ultimately into the cylinders 20 via the intake manifold 32. The charge air cooler 28 is shown receiving a combination of EGR gas 54 and fresh air 34 as provided by the EGR mixer 26. In some embodiments, the air intake system 14 can additionally or alternatively include one or more of a dedicated EGR cooler (not shown) in fluid communication with EGR conduit 52 and configured to cool EGR gas 54 prior to the EGR mixer 26, and an intercooler (not shown) in fluid communication with conduit 66 and configured to cool compressed fresh air 34 prior to the EGR mixer 26. In a specific embodiment (not shown), the charge air cooler 28 is positioned upstream from the EGR mixer 26.

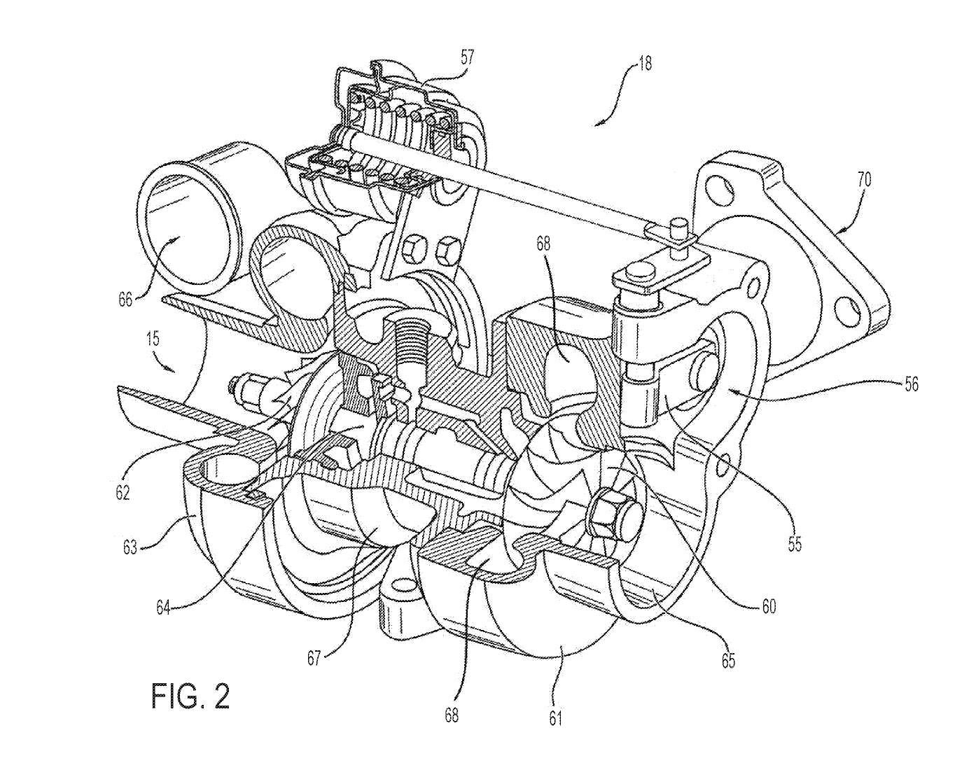

As mentioned above, the air intake system 14 and the exhaust system 16 may be in mechanical communication through a turbocharger 18. As shown in FIG. 2, the turbocharger 18 includes a turbine 60 in fluid communication with the exhaust system 16 and a compressor 62 in fluid communication with the intake system 14. The turbine 60 and the compressor 62 can be mechanically coupled via a common rotatable shaft 64 which extends through a bearing housing 67. The turbine 60 can be disposed within a turbine housing 61, and similarly the compressor 62 can be disposed within a compressor housing 63. In operation, the turbine 60 receives exhaust gas 40 via manifold 70. Specifically, manifold 70 communicates exhaust gas 40 from at least one of cylinders 1-4 to the circumferential volute, or scroll, 68. Manifold 70 can be integrated with turbine housing 61 in some embodiments, for example as a one-piece construction. In some embodiments, integrating manifold 70 with turbine housing 61 provides the greatest reduction in thermal and pressure losses. In some other embodiments, manifold 70 is a single-piece construction separate from turbine housing 61. The turbine 60 captures kinetic energy from the exhaust gases 40, and spins the compressor 62 via the common shaft 64. Volumetric restrictions of the exhaust gas 40 within the turbine housing 61 convert thermal energy into additional kinetic energy which is similarly captured by the turbine 60. For example, volute 68 can be particularly optimized to effect the conversion of thermal energy to kinetic energy.

The rotation of the compressor 62 via the common shaft 64 then draws in fresh air 34 from the inlet 15 and compress it into the remainder of the intake system 14. For example, the compressor 62 can communicate compressed air to the intake system 14 via conduit 66. The variable flow and force of exhaust gases 40 can influence the amount of boost pressure that can be imparted to fresh air 34 by the compressor 62, and subsequently the amount of oxygen capable of being delivered to cylinders 20. In many instances, maximum translation of energy from exhaust gas 40 to compressor 62 is desired. In some instances, boost pressure exerted by the compressor 62 can be limited by an optional wastegate valve 55. The wastegate valve 55 can divert exhaust gas 40 away from the turbocharger turbine 60 towards the tailpipe 44, for example via a wastegate conduit 56, thereby limiting boost pressure. Wastegate valve 55 can be actuated via actuator 57, for example.

The engine assembly 10 includes a dedicated EGR system 50 that may directly route (e.g., via an EGR conduit 52) the EGR gas 54 from one or more dedicated cylinders of ICE 12 back into the intake system 14. This recirculated EGR gas 54 may mix with the fresh air 34 at the EGR mixer 26, for example, and may correspondingly dilute the oxygen content of the mixture. The use of EGR can increase the efficiency in spark ignition engines. EGR can also reduce the combustion temperature and NOx production from ICE 12. Routing the entire exhaust of one cylinder 20, or the entire exhaust gas of less than all of cylinders 20 back to the intake assembly 14 is referred to herein as “dedicated EGR.” Dedicated EGR can include embodiments where substantially all of the exhaust gas of one cylinder 20, or less than all cylinders 20 is routed back to the intake assembly 14.

In general, manifold 70 comprises a body having a plurality of veins which converge therein, wherein at least one of the plurality of veins is in exclusive fluid communication with a dedicated EGR cylinder, or a plurality or dedicated EGR cylinders. Each vein within the manifold 70 can communicate exclusively with a dedicated conduit, such as dedicated conduits 21-24, or can communicate with a plurality of dedicated conduits, such as conduits 22 and 23. Dedicated conduits 21-24 are optional, and serve only to effect fluid communication between the manifold veins and the cylinders of an ICE, such as cylinders 1-4 or ICE 12. As shown in FIG. 1 as a non-limiting example, veins 21′, 22′, 23′, and 24′ fluidly communicate with dedicated conduits 21, 22, 23, and 24, respectively, the latter of which communicate with respective ICE 12 cylinders. In some embodiments, one or more optional dedicated conduits can converge before fluidly communicating with a manifold vein. In other embodiments, manifold 70 can directly communicate with ICE 12 cylinders. For example, manifold 70 can be directly affixed to cylinder block 11. The manifold body can be metal, carbon fiber, or other like materials which exhibit high thermal stability.

A conduit within manifold 70 which is in exclusive fluid communication with a dedicated EGR cylinder or a plurality of dedicated EGR cylinders can be referred to as a dedicated EGR vein. Accordingly, as shown, vein 24′ comprises a dedicated EGR vein. In some embodiments, manifold 70 comprises at least three veins which converge therein, wherein at least two, but less than all, of the at least three veins are dedicated EGR veins. An EGR bypass valve, such as EGR bypass valve 71, is provided within the one or more dedicated EGR veins of manifold 70 for bypassing exhaust gas from one or more dedicated EGR cylinders to conduit 52. The one or more EGR bypass valves are disposed such that exhaust gas within the dedicated EGR vein can be bypassed to EGR conduit 52 before contacting one or more of exhaust gas from non-dedicated EGR veins, and the turbocharger turbine, such as turbine 60. For the purpose of illustration, EGR bypass valve 71 is shown within vein 24′ in fluid communication with dedicated cylinder 4 (via optional dedicated conduit 24), and veins 21′, 22′, and 23′. Vein 24′ converges with veins 21′, 22′, and 23′ on the downstream side 71′ of EGR bypass valve 71, whereafter all veins collectively fluidly communicate with turbine 60. The manifolds disclosed herein, such as manifold 70, which include an integrated EGR bypass valve increase the efficiency of turbochargers, such as turbocharger 18, by reducing pressure drop and thermal loss of exhaust gas, such as exhaust gas 40, between one or more dedicated cylinders, such as cylinder 4, and the turbocharger turbine, such as turbine 60. The EGR bypass valve 71 configurations provided herein minimize the cylinder-to-turbine path geometric and volumetric variations between dedicated and non-dedicated cylinders.

As illustrated in FIG. 1, optional dedicated conduits 21, 22, 23, and 24 are in fluid communication with corresponding veins 21′, 22′, 23′ and 24′, respectively, which converge within manifold 70 in order to deliver exhaust gas 40 to turbine 60. Veins 22′ and 23′ are shown converging prior to converging with veins 21′ and 24′, however such an orientation is optional, and any permutation of non-dedicated EGR vein convergence is to be considered within the scope of this disclosure. Cylinder 4 is shown as a dedicated EGR cylinder by virtue of its association with an EGR bypass valve 71, the latter disposed in fluid communication with vein 24′, EGR conduit 52, and turbine 60. As desired, exhaust gas 40 expelled from cylinder 4 can be communicated to turbine 60 or diverted to EGR conduit 52 via EGR bypass valve 71. In either instance of operation, the exhaust gas 40 of the remaining cylinders 20 (i.e., cylinders 1-3) is communicated to the exhaust assembly 16, for example via conduits 56 and 65. In other embodiments, a plurality of cylinders, but less than all cylinders can supply 100% of their EGR gas 54 back to the intake assembly 14. For example, cylinder 1 and 4 can supply 100% of their EGR gas 54 back to the intake assembly 14, and the exhaust gas 40 of cylinder 2 and 3 can be expelled from ICE 12 via the exhaust assembly 16. In such an embodiment, manifold 70 can comprise a single EGR bypass valve, such as EGR bypass valve 71, disposed in fluid communication with dedicated EGR veins 21′ and 24′, or can alternatively comprise two individual EGR bypass valves each disposed in fluid communication with dedicated EGR veins 21′ and 24′, respectively. In some embodiments, conduit 56 and conduit 65 can converge within manifold 70.

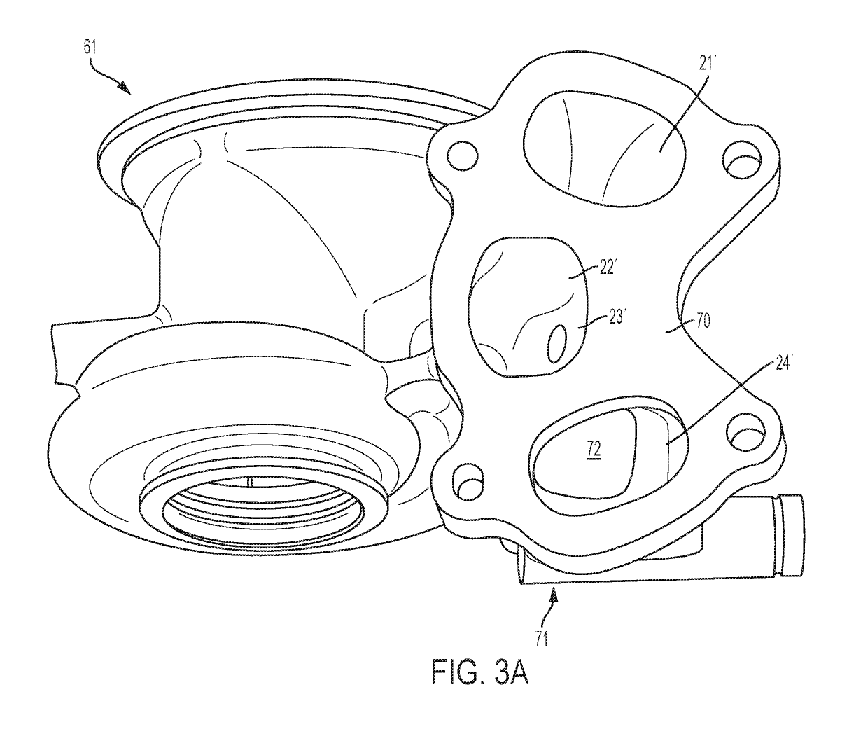

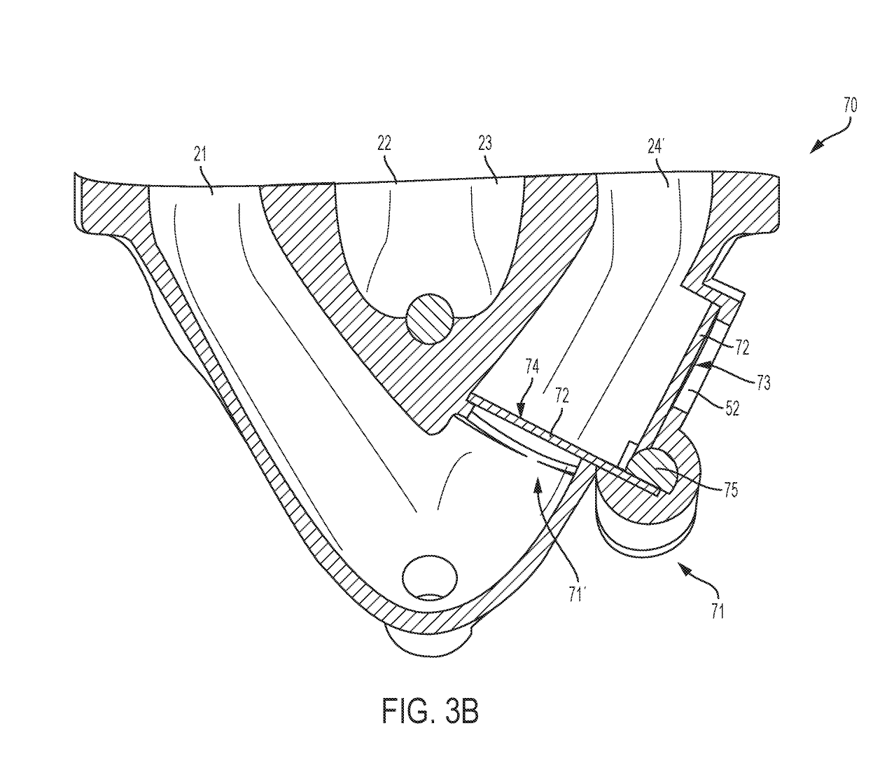

FIG. 3A illustrates a perspective view of manifold 70 incorporated into turbine housing 61. FIG. 3B further illustrates a cutaway view of manifold 70. Manifold 70 comprises a two-way EGR valve 71 which includes a gate 72 movable between a first position 73 and a second position 74. Gate 72 is configured to manage fluid communication between vein 24′ (the dedicated EGR vein) and one or more of vein 21′, vein 22′, vein 23′, turbine 60, and EGR conduit 52. Managing fluid communication can include one or more of selectively allowing, obstructing, or preventing fluid communication. Gate 72 can be controlled by an EGR valve actuator 75, for example, which can actuate gate 72 between first position 73 and second position 74. When gate 72 is in first position 73, EGR vein 24′ is in fluid communication with one or more of vein 21′, vein 22′, vein 23′, and turbine 60, and exhaust gas within EGR vein 24′ can be communicated to turbine 60. When gate 72 is in second position 74, vein 24′ is in fluid communication with EGR conduit 52, and exhaust gas within EGR vein 24′ is communicated to EGR conduit 52. Veins 22′ and 23′, and veins 21′ and 24′ are shown as converging, respectively, before being introduced to turbine 60. One of skill in the art will recognize that such a configuration is optional, and the convergence of any or all veins downstream of EGR valve 71 within manifold 70 is within the scope of this disclosure.

In some embodiments, two-way EGR valve 71 can be replaced with two one-way valves which are one-way relative to the dedicated EGR vein 24′ and prevent fluid flow from the turbine 60, one or more non-dedicated EGR veins 21′-23′, or EGR conduit 52 in an upstream direction towards dedicated vein 24′ or cylinder 4. A single one-way valve can occupy each of first position 73 and second position 74, for example. Each of the one-way valves can be actuated by the same or separate actuators.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A turbocharger comprising:
a compressor disposed within a compressor housing; and
a turbine mechanically coupled to the compressor and disposed within a turbine housing, wherein the turbine housing includes a manifold having a plurality of veins which converge therein and establish fluid communication with the turbine, and one of the veins is a dedicated exhaust gas recirculation (EGR) vein having an EGR bypass valve.

2. The turbocharger of claim 1, wherein the dedicated vein converges with at least one of the remaining veins downstream from the EGR bypass valve.

3. The turbocharger of claim 1, wherein the manifold and turbine housing are a one-piece construction.

4. The turbocharger of claim 1, wherein the EGR bypass valve can selectively allow or prevent fluid communication between the dedicated EGR vein and the turbine.

5. The turbocharger of claim 1, wherein the dedicated EGR vein is in fluid communication with an EGR conduit.

6. The turbocharger of claim 5, wherein the EGR bypass valve can selectively allow or prevent fluid communication between the dedicated EGR vein and the EGR conduit.

7. The turbocharger of claim 5, wherein the EGR bypass valve comprises a two-way valve having a gate movable from a first position to a second position, wherein when the gate is in the first position the dedicated EGR vein is in fluid communication with the turbine, and when the gate is in the second position the dedicated EGR vein is in fluid communication with the EGR conduit.

8. The turbocharger of claim 1, further comprising a wastegate valve disposed downstream from the EGR bypass valve.

9. A turbocharger turbine manifold, the manifold comprising:
a body;
at least one non-dedicated exhaust gas recirculation (EGR) vein;
a dedicated EGR vein; and
an EGR bypass valve in fluid communication with the dedicated EGR vein, wherein the dedicated EGR vein converges with the at least one non-dedicated EGR veins downstream from the EGR bypass valve.

10. The manifold of claim 9, wherein the dedicated EGR vein is in fluid communication with an EGR conduit.

11. The manifold of claim 10, wherein the EGR bypass valve can selectively allow or prevent fluid communication between the dedicated EGR vein and the EGR conduit.

12. The manifold of claim 10, wherein the EGR bypass valve comprises a two-way valve having a gate movable from a first position to a second position, wherein when the gate is in the first position the dedicated EGR vein is in fluid communication with the at least one non-dedicated EGR veins, and when the gate is in the second position the dedicated EGR vein is in fluid communication with the EGR conduit.

13. The manifold of claim 9, further comprising a wastegate valve disposed downstream from the EGR bypass valve.

14. An exhaust gas recirculation (EGR) system, the system comprising:
an internal combustion engine having an air intake manifold configured for delivering air to a plurality of cylinders, wherein one of the plurality of cylinders is a dedicated EGR cylinder;
an EGR conduit in fluid communication with the air intake manifold; and
a turbocharger having a turbine disposed within a turbine housing and in fluid communication with each of the plurality of cylinders via a turbine manifold, the turbine manifold including:
a body;
at least one non-dedicated EGR vein disposed within the body;
a dedicated EGR vein disposed within the body in fluid communication with the dedicated EGR cylinder and the EGR conduit; and
an EGR bypass valve in fluid communication with the dedicated EGR vein, wherein the dedicated EGR vein converges with the at least one non-dedicated EGR veins downstream from the EGR bypass valve.

15. The system of claim 14, wherein the EGR bypass valve comprises a two-way valve having a gate movable from a first position to a second position, wherein when the gate is in the first position the dedicated EGR vein is in fluid communication with the at least one non-dedicated EGR veins, and when the gate is in the second position the dedicated EGR vein is in fluid communication with the EGR conduit.

16. The system of claim 14, wherein the EGR bypass valve can selectively allow or prevent fluid communication between the dedicated EGR vein and the EGR conduit.

17. The system of claim 14, wherein the manifold and turbine housing are a one-piece construction.

18. The system of claim 14, further comprising a conduit in fluid communication with at least one of the one or more non-dedicated EGR cylinders and at least one of the non-dedicated EGR veins.

19. The system of claim 14, further comprising a conduit in fluid communication with the dedicated EGR cylinder and the dedicated EGR vein.

20. The system of claim 14, wherein the EGR bypass valve comprises two one-way valves.
